(19) United States
(12) Patent Application Publication
(10) Pub. No.: US 2005/0266867 A1
(43) Pub. Date: Dec. 1, 2005

(54) Communications facilitation method and apparatus

(75) Inventors: John M. Harris, Chicago, IL (US); Ronald T. Crocker, St. Charles, IL (US); Thomas B. Hart, West Dundee, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/856,150

(22) Filed: May 28, 2004

(51) Int. Cl. H04Q 7/20

(52) U.S. Cl. 455/509; 455/514; 455/515

(57) ABSTRACT

A core network element in a communication system can serve to store information regarding a present communication location of a given communication unit that seeks to facilitate a wireless communication using one kind of wireless communication resource (such as a dedicated voice channel) via another kind of wireless communication resource (such as a shared data channel). Upon receiving an indication from a communication unit regarding a target communication unit, the core network element can also make a determination regarding the likely availability of that target communication unit. A corresponding message that corresponds to this likelihood of availability can then be returned to the communication unit (using, preferably, the previously stored communication location information to essentially target the use of system resources to effect delivery of this message). The communication unit, in turn, can use this preliminary indication to facilitate its own subsequent actions.

### FIELD OF THE INVENTION

This invention relates generally to the facilitation of wireless communications.

### BACKGROUND OF THE INVENTION

Wireless communications of various kinds and styles are well known in the art. This includes both voice and data services. Wireless communication services based upon telephony-styled service (such as cellular services) are nearly ubiquitous in many countries. Service providers and system consumers of such services are increasingly interested in so-called push-to-talk services. In a typical push-to-talk service offering, a user asserts a push-to-talk button on their communication unit and waits for a particular audible tone. This tone signals that the user can begin speaking to a target recipient. Reducing the latency between asserting the push-to-talk button and the rendering of that audible signal comprises an important design requirement for both system operators and system users.

In a not-untypical deployment, a communication unit responds to assertion of the push-to-talk button by sourcing a short data burst transmission to alert a system push-to-talk server of a push-to-talk request. This transmission will typically include, for example, identifying information for one or more target communication recipients. Following this transmission, the communication unit then automatically begins a series of message exchanges that establish a voice channel. Push-to-talk authorizations (or refusals) are then transmitted to the communication unit via that voice channel.

The above configuration can provide satisfactory service under at least some operating circumstances. In many instances, however, such an approach leaves much to be desired. Presuming availability of the target communication unit, this approach can require at least three seconds between assertion of the push-to-talk button and provision of the speak tone to the user. Such a delay can be objectionably long to many users. This delay can also be frustrating when the system must deny push-to-talk service for whatever reason (such as present unavailability of the target communication unit). Furthermore, establishing a voice channel merely to inform the communication unit that push-to-talk service is presently denied can burden the communication resources of a given system.

### BRIEF DESCRIPTION OF THE DRAWINGS

The above needs are at least partially met through provision of the communications facilitation method and apparatus described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a general signal flow timing diagram as configured in accordance with various embodiments of the invention; and

FIG. 6 comprises an illustrative signal flow timing diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Generally speaking, pursuant to these various embodiments, a core network element is configured and arranged to store communication pathway information for a communication unit that seeks to establish a wireless communication (such as a push-to-talk communication) using a first type of wireless communication resource to facilitate communications with at least a first communication target. Upon receiving a message from such a communication unit via a second type of wireless communication resource, which message identifies the desired communication target, the network element can store the communication pathway information regarding a present communication location and then determine whether the communication target is likely available for communications (as versus, for example, determining with absolutely certainty that the communication target is available). Likely (as versus certain) availability of the communication target then serves as a basis for providing a kind of preliminary approval to the requesting communication unit. Pursuant to the above approach, this preliminary approval can be delivered to the requesting communication unit via the second type of communication resource and also via use of the information regarding the communication location as corresponds to that requesting communication unit.

Pursuant to a preferred approach, the first type of wireless communication resource can comprise a dedicated channel (such as but not limited to a voice communication resource) and the second type of wireless communication resource can comprise a common channel (such as but not limited to a data communication resource that supports, for example, short data burst messages).

So configured, a requesting communication unit can often be provided with at least a preliminary indication that the target communication unit is available. Based upon that indication, the communication can provide a speak tone to the user prior to actual establishment of the voice channel. In such a case, buffering techniques can be employed to temporarily store the user's verbal input pending availability of the voice channel (once the voice channel becomes available, the buffered speech can then be unspooled and transmitted). This can result in a dramatic reduction in delay between assertion of the push-to-talk button and the opportunity to begin speaking as this preliminary assessment regarding likely availability of the communication target and provision of corresponding information regarding such availability using the stored location information can often be effected in only a few milliseconds. This approach also has the benefit of avoiding the need to establish a voice channel when a communication target does not appear to be likely available, thereby avoiding an ultimately unnecessary allocation of system resources (i.e., the dedicated talk channel).

These and other benefits will become more evident to those skilled in the art upon making a thorough review and study of the following detailed description.

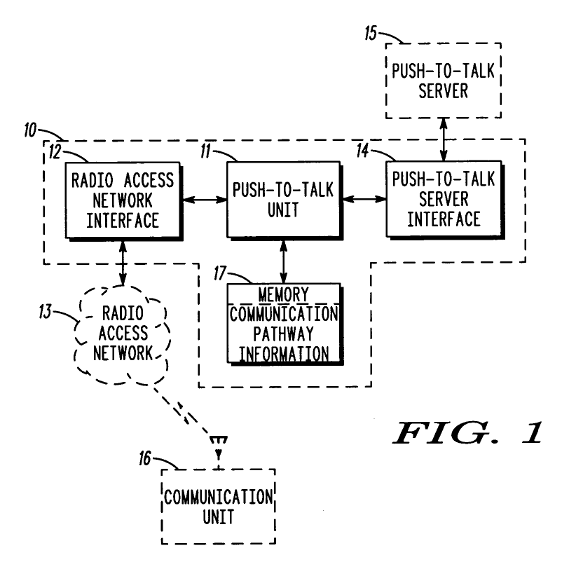

Referring now to the drawings, and in particular to FIG. 1, any of a wide variety of core network elements 10, alone or in combination with one another, can serve as an enabling platform to effect one or more of the teachings set forth herein. For example, a core network element 10 can comprise a packet control function, a packet data services node, or the like, alone or in combination with one another) (It will therefore be understood that, although the singular “core network element” will often be used herein for purposes of explanation, the expressions “core network element” and “network element” are also to be read to include a plurality and/or combination of such elements.).

In addition to such other functionality and supporting components as such a network element 10 will ordinarily feature in accord with prior art practice, pursuant to these embodiments, the core network element 10 will further comprise a push-to-talk unit 11 that operably couples via a radio access network interface 12 to a radio access network 13 (the latter being well known and understood in the art). In a similar fashion, the push-to-talk unit 11 can also couple via a push-to-talk server interface 14 to a push-to-talk server 15 (as is also well known and understood in the art).

So configured, the push-to-talk unit 11 serves to facilitate the communication needs of a wireless communication unit 16 and in particular the push-to-talk communication needs of such a user. In particular, when the communication unit 16 seeks to instigate a push-to-talk communication, the core network element 10 can serve to store communication pathway information as presently corresponds to that communication unit 16 in a corresponding memory 17 (which memory 17 can be local and integral to the core network element 10 as suggested by the illustration or remote and/or distributed in accord with well understood prior art memory management practice). The communication pathway information can identify, for example, a particular radio access network sector or other network endpoint with which the communication unit 16 most recently communicated. In turn, the core network element 10 can access that stored location information when providing information to that communication unit 16 regarding likely availability of an identified target communication unit.

In a preferred embodiment the radio access network will support at least two types of differing communication resources. One such communication resource can comprise, for example, a shared paging communication resource that will support, for example, short data bursts. Such short data bursts can serve well to transmit initial communication requests, identification information regarding a target communication unit, messages reflecting the likely availability of the target communication unit, and the like. The other communication resource can comprise, for example, a dedicated communication channel useful, when allocated, to support a voice communication between the communication unit and the target communication unit.

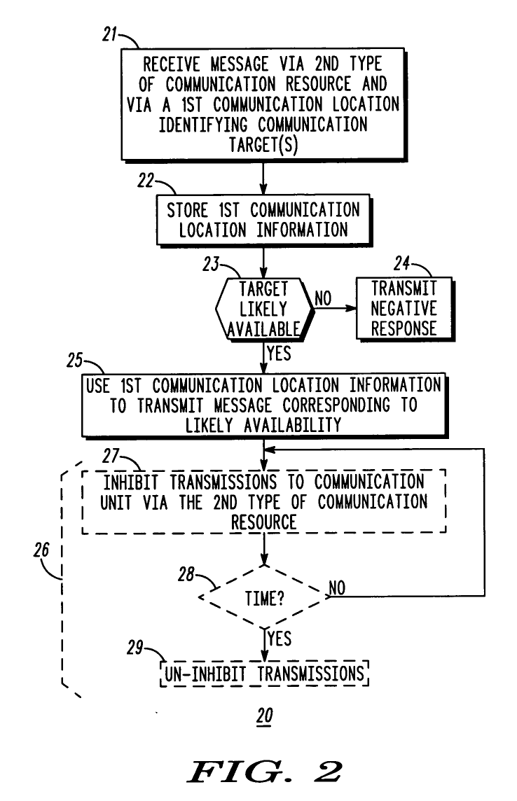

Such an embodiment (or such other embodiment as can serve to effect the following teachings) can be programmed or otherwise configured and arranged, by those skilled in the art, to effect all or a relevant portion of a process 20 as is depicted in FIG. 2. This process 20 serves to facilitate establishment of a first type of wireless communication resource (such as, but not limited to, a dedicated channel and/or a voice communication resource) to thereby aid in facilitating communications between a communication location and a communication target. Pursuant to this process 20, the network element receives 21 a message from the communication location via second type of wireless communication resource that is different from the first wireless communication resource (for example, the second type of wireless communication resource can be a common channel that supports data communications via, for example, a contention or paging protocol or other shared resource protocol).

In a preferred approach this message comprises, at least in part, information that identifies the communication target (by providing, for example, a system identifier, an Internet Protocol identifier, a network access identifier, a communication target alias, or the like). Also in a preferred approach this message comprises a short data burst message.

The received message is typically received by the radio access network and, more particularly, via a particular part of that radio access network (for example, via a particular wireless endpoint sector). In general, and as is well understood by those skilled in the art, the transmissions of the communication unit will tend to be best received at a particular radio access network access point such as a base station that is most proximal to the communication unit at the time of making such transmissions. Pursuant to this process 20, such information comprises communication location information that indicates, for example, this particular wireless endpoint sector and is stored 22 by the network element (using, for example, the above-described memory). Various network elements are presently well-suited for such storage tasks including but not limited to packet control functions and mobile switching centers.

This process 20 then provides for determining 23 whether the communication target is likely available for a communication. Contrary to typical prior art practice (which often requires making actual contact with the communication target to confirm its certain availability) this process 20 seeks, at this point, to only glean a likelihood regarding such availability. Consequently, actual contact with the communication target is not a necessary practice at this point in the process. Instead, presence information regarding the communication target can be accessed and processed to develop the desired sense of likelihood.

As those skilled in the art will understand, presence information comprises various kinds of information regarding a given communication unit's present (or recent) geographical or network-access location, operational status (i.e., whether presently engaged in an active or dormant operational state and/or whether presently engaged in another communication), and so forth. Although such presence information does not always reflect present status of a given communication unit, such information will nevertheless likely serve, in most instances, as a useful indication of whether a given communication unit is likely available to communicate with the requesting communication unit.

For example, when presence information for the target communication unit indicates that the target communication unit is available within the system and is not presently engaged in another communication, that information can be used to justify a determination that the target communication unit is likely available to communicate with the communication location. Of course, such presence information can become stale with the passage of time. Therefore, if desired, the determination of likelihood can be weighted one way or the other with respect to the age of the presence information. To illustrate, presence information that is more than ten minutes old might be discounted by a 50% factor, while presence information that has not been updated for more than 30 minutes might be discounted in its entirety.

When the process 20 concludes that the communication target is likely not available, a corresponding negative response can be transmitted 24 to the communication unit. Pursuant to one embodiment this can conclude a present attempt to facilitate the desired communication. Pursuant to another embodiment this can result in a temporary pause in the present attempt to facilitate the desired communication with a subsequent re-try occurring as per, for example, a corresponding schedule.

When the process 20 concludes instead that the communication target is likely available, a corresponding message can be transmitted 25 to the requesting communication unit. In a preferred approach the network element uses the previously stored information regarding the communication location to facilitate a well-targeted transmission to the communication unit. This in turn can result in assuring an effective and efficient use of the communication resources of the network. For example, this message of affirmation can be transmitted using only the resources of a single wireless endpoint sector (i.e., as corresponds to the stored and recovered communication location information) rather than multiple such resources (such as might occur with a system-wide page) and still have at least a reasonable likelihood of reaching the desired communication unit.

In both cases, and pursuant to a preferred approach, both negative and positive responses corresponding to the likelihood of availability of the target communication unit are transmitted as short data burst messages using the second type of communication resource.

As is well understood in the art, a given communication unit can subscribe or interact in other dynamic ways with respect to presence information. For example, a communication unit in many systems can request to be updated from time to time regarding the present location and/or availability of the members of a self-designated group of individuals. In such a system, it would also be possible to include with such messages as those noted above (i.e., the negative and positive responses) presence information as corresponds to the communication location. This can aid in minimizing required resources to maintain the currency of such information for a given communication unit. It can also reflect the likelihood that a communication unit user who has just asserted an indication of a desire to instigate a push-to-talk communication may wish to engage in other such communications as well in the relatively near future. Updated presence information may well support the immediate needs of such a user under such circumstances.

As will be shown below, when a wireless communication has been configured to leverage a process and exchange of information as set forth above, a considerable improvement with respect to latency can typically be expected. Such an approach can also be used with wireless communication units that have not been configured to take advantage of such content. Such units, subsequent to transmitting their initial request, will then typically automatically initiate the process of acquiring a voice channel. In most instances it may be expected that the network element response will be available prior to establishment of this voice channel. As a result, transmission of the likelihood-of-availability response via the second type of communication resource may interfere with the attempts of the communication unit to use that resource to establish the voice channel (such a coincidence of transmission efforts is sometimes referred to as “glare” by those skilled in the art).

To accommodate such an instance, the above-described process 20 can be provided with an optional sub-process 26 that serves to inhibit 27 transmissions to the communication unit via the second type of communication resource (i.e., the communication resource that the communication unit is now likely using to attempt to establish a dedicated channel to support its subsequent anticipated communication activities). Such inhibiting 27 can be rendered subject to a predetermined trigger event such as, for example, expiration of a predetermined period of time 28. Upon detecting such a predetermined trigger event this sub-process 26 can un-inhibit 29 such transmissions. Such a sub-process 26 can be utilized at times and in response to events other than as specifically depicted in FIG. 2 as desired and as may be more appropriate to a given configuration and system deployment.

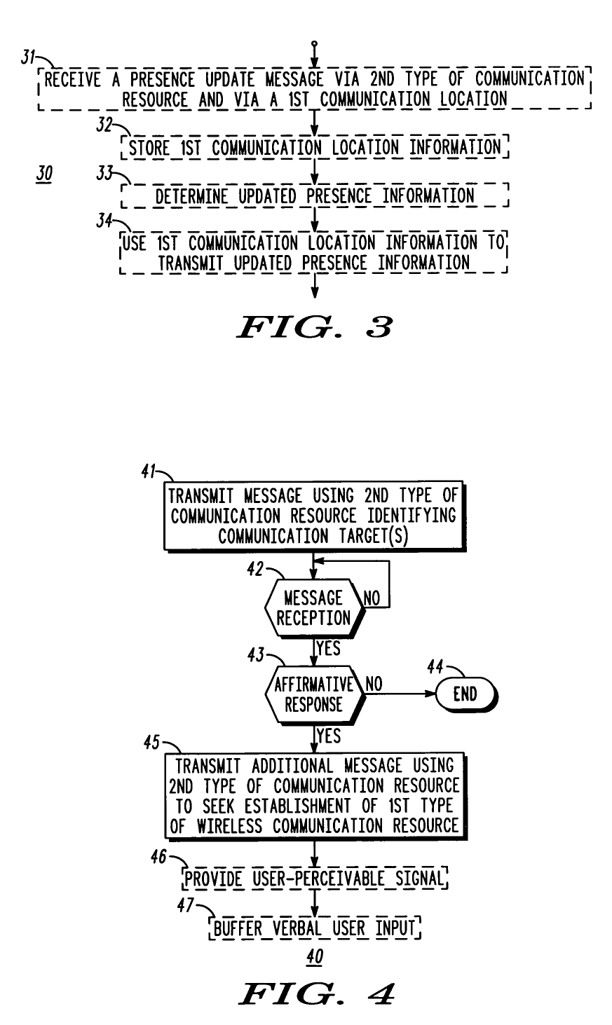

As noted earlier, the above process can accommodate the provision of presence information in combination with contemporaneous transport of other information, such as call-setup protocols, target communication unit identifiers, and so forth. Those skilled in the art will appreciate that these basic teachings can also be applied more discreetly to the handling of presence information. To illustrate, and referring now to FIG. 3, a corresponding process 30, upon receiving 31 a message comprising a presence update message from a communication unit via the second type of communication resource and via a corresponding communication location, can again provide for the storage 32 of the information regarding the corresponding communication location. Upon determining 33 the requested updated presence information (such as, but not limited to, updated presence information for members of a predetermined so-called buddy list), this process 30 can then again use 34 the stored information regarding the corresponding communication location to transmit a reply message comprising, at least in part, the updated presence information, to the requesting communication unit via the second type of wireless communication resource. Again, it will be appreciated that the storage and subsequent use of the communication pathway information as pertains to the communication unit can permit efficient and leveraged use of the available wireless resources when supporting presence services.

As noted above, as least some of these embodiments are suitable for compatible use with unmodified communication units (i.e., communication units that otherwise operate in accord with standard call-establishment protocols and approaches). In at least some instances, however, better efficiencies and user satisfaction may result upon affording an opportunity to the communication unit to itself better employ and leverage these teachings. Referring now to FIG. 4, a communication unit can be configured and arranged to employ a process 40 that aids in facilitating establishment of a first type of wireless communication resource to thereby facilitate communication (including but not limited to push-to-talk communication) with at least a first communication target. Pursuant to this process 40, the communication unit can transmit 41 a message that identifies the first communication target using a second type of wireless communication resource (such as, but not limited to, a short data burst message on a common channel communication resource (such as a paging channel communication channel as are known in the art)). Upon then receiving 42 a responsive message via the second type of wireless communication resource (such as, again, a short data burst message), this process 40 determines 43 whether that responsive message comprises an affirmative response or a negative response.

When the responsive message comprises a negative response (such as, to illustrate, a message such as a 486 BUSY message, a 404 NOT FOUND message, a 421 INCORRECT FORMAT message, a 480 TEMPORARILY UNAVAILABLE message, or a 500 INTERNAL SERVER ERROR message, to name a few) the process 40 can end 44. When the responsive message comprises an affirmative response that serves, in this context, as an indication that the target communication unit is likely available (as distinct from assuredly available) (such as, to illustrate, a 100 TRYING message, a 200 OK message, or a message having informational content corresponding to substance such as, but not limited to, a previous call having ended due to loss of a sufficient radio frequency carrier, age of available presence information, a previous call attempt having failed due to expiration of an attempt window, or unavailability of a required quorum of communication targets when seeking to facilitate establishment of the first type of wireless communication resource to facilitate communication with a plurality of communication targets), the process 40 can provide for transmission 45 of at least one additional message using the second type of wireless communication resource to seek establishment of the first type of wireless communication resource (the content of the latter transmission according, for example, with prior art methodology).

If desired, this process 40 can optionally further effect provision 46 of a user-perceivable signal upon receiving an affirmative response. This can comprise, for example, a same kind of audible tone and signal as is already used in prior art platforms to announce and indicate to a user that they may begin speaking. Since pursuit of this optional process 40 will typically result in provision of this signal prior to a talk channel having been established, this process 40 can also optionally provide for the buffering 47 of verbal user input as received prior to completing the communication link to the communication target via the first type of wireless communication resource. (The buffering of speech, and the subsequent unspooling and playback of such buffered information, comprises a generally well-understand area of endeavor and therefore additional elaboration will not be provided here for the sake of brevity and the preservation of focus.)

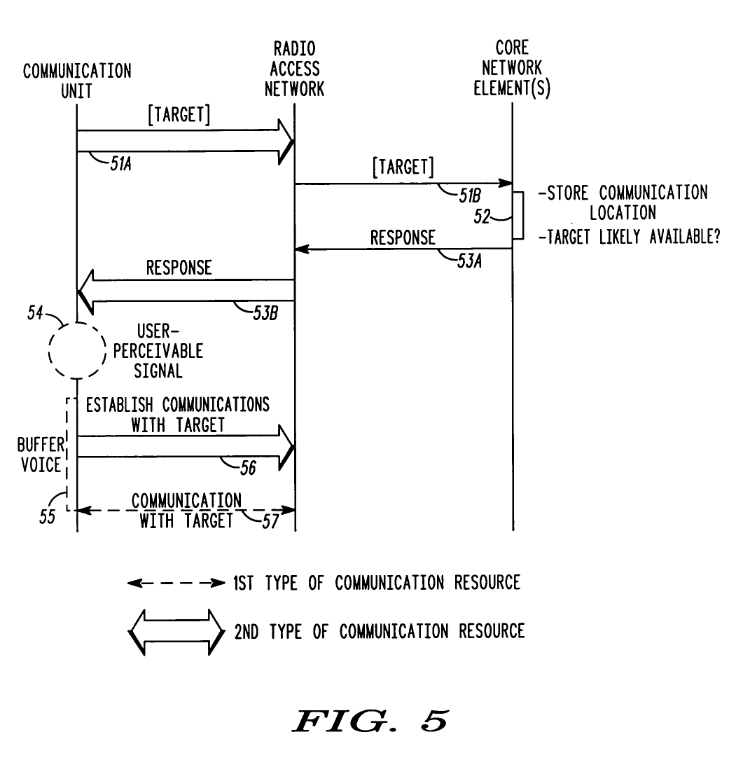

FIG. 5 provides a relatively high level view of at least some of the above-described processes. A communication unit typically initiates the process by transmitting a first message 51A that identifies at least one target communication unit (“TARGET”) to a radio access network. The latter forwards information regarding this content in another message 51B to one or more core network elements along with, in a preferred embodiment, information regarding the communication pathway used by the communication unit to communicate with the radio access network. The core network element(s) stores 52 this communication pathway information and make a determination regarding likely availability of the target communication unit (for example, by accessing previously stored presence information as corresponds to the target communication unit). The core network element(s) then transmits a corresponding response message 53A to the radio access network that includes information regarding the communication pathway to use when forwarding that response in another message 53B to the communication unit.

Upon receipt of an affirmative response (corresponding to likely availability of the target communication unit) the communication unit can provide the user-perceivable signal 54 and begin buffering the user's input speech 55 while also then undertaking its protocol signaling 56 to establish communication with the target communication unit. (Pursuant to a preferred approach, the above signaling and messaging as between the communication unit and the radio access network is conducted via short data message bursts using a paging-style communication resource). Upon establishing the desired communication link 57 (such as a dedicated voice channel) the communication unit can then conduct the desired communication with the target communication unit. This can include automated playback and transmission of previously buffered speech as was input by the user subsequent to the provision of the user-perceivable signal 54 and establishment of the desired communication link 57.

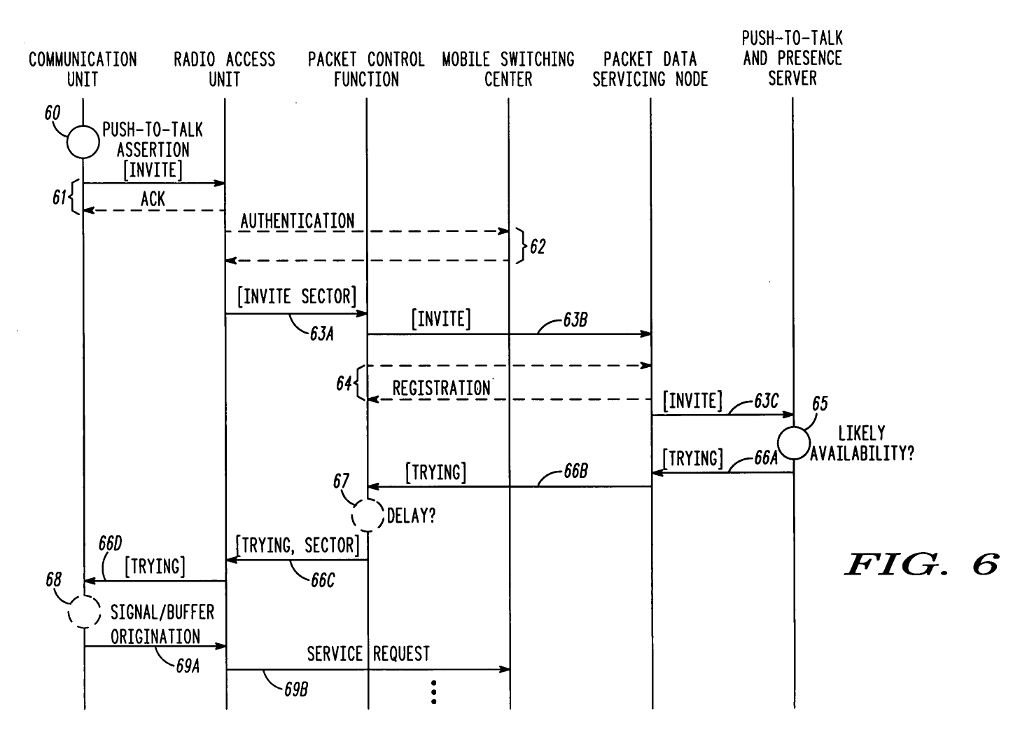

To further illustrate these teachings, and referring now to FIG. 6, a communication unit user seeking to establish a push-to-talk communication link with a given target communication unit, upon asserting 60 a push-to-talk button on the communication unit will cause the communication unit to conduct a short data burst transaction 61 using a shared access channel such as a paging channel. This transaction 61 can comprise at least the transmission of a session initiation protocol INVITE message to a radio access network as is understood in the art along with, if desired, an acknowledgement from the radio access network to the communication unit. The short data burst data can be encapsulated, if desired, in an IS-707-A-2 compliant data burst message in accord with well understand prior art practice.

Optionally, the radio access network can conduct an authentication session 62 with, for example, a mobile switching center. Such a process can be used, for example, to authenticate the communication unit's pre-authorized status to submit an INVITE message and to otherwise seek to make use of the resources of the network. Such an authentication session 62 can be realized in any of a wide variety of ways including through use of a session initiation protocol ADDS transfer and acknowledgement exchange.

The radio access network can then forward the INVITE content to a packet control function using, for example, an A9 short data delivery message 63A. In a preferred approach, this message 63A includes both the INVITE content as well as information regarding the communication location or other pertinent communication pathway information as presently corresponds to the communication unit. For example, when the location/pathway information identifies a particular radio access network endpoint sector, that SECTOR information can be provided along with the INVITE content to the packet control function. In a preferred embodiment at least one new message field is defined to specifically accommodate such SECTOR information though, if desired, such information may be combined with other information in an application that supports such combination and eventual recovery parsing.

In this embodiment, the packet control function stores the communication location information (i.e., the SECTOR information in this illustrative example). As noted earlier, this storage can be locally accommodated or remotely supported as may best suit the needs or capabilities of a given system. The packet control function, in this embodiment, then forwards the INVITE content in an A10 data packet message 63B to a packet data services node. In another embodiment, if desired, the SECTOR information could also be forwarded to the packet data services node (or elsewhere as desired), but in this embodiment, the packet control function stores the communication location information and there is no particular need to forward such information any further.

At this time, or at some other time as may be convenient or appropriate in a given setting, the packet control function can also optionally effect a registration process 64 using, for example, an exchange of an A11 registration request and an A11 registration response. In any event, the packet data services node then submits the INVITE content in a message 63C to a push-to-talk server which, in this embodiment, also serves as a presence server (those skilled in the art will recognize that these functions are also readily parsed and separately deployed if desired). This push-to-talk and presence server then uses the information in the INVITE message that identifies the target communication unit to make a determination 65 regarding the likely availability of that target communication unit to communicate at present with the originating communication unit. This determination can be based, for example, on presence information as may presently be available regarding the target communication unit as versus information gleaned in present real time from the target communication unit.

When there appears to be a reasonable likelihood that the target communication unit will likely be available to participate in a communication (where “likely” can comprise a static or dynamic concept and can further be set as conservatively or as liberally as may be desired to best suit the operational strategy of a given system operator), the push-to-talk and presence server can source a corresponding affirmative message 66A (such as, but not limited to, a 100TRYING message as is understood and known in the art) to the packet data services node. The latter can then forward a corresponding message 66B to the packet control function.

As described above, in some systems it may be desirable to interpose a delay 67 in order to avoid the glare that may otherwise result should the packet control function source a transmission at this time to the communication unit. Such a delay 67, when used, can be for as long or as short as desired and can further be dynamically altered to respond to changing operational conditions if desired.

The packet control function then sources an A9 short data delivery message 66C that includes both the affirmative response (i.e., the 100TRYING content in this illustration) as well as the communication location information (i.e., the SECTOR information as was stored earlier by the packet control function). (The recovery of such location information can be facilitated, for example, by use of a table-based sector-to-A10 tunnel identifier list.) The radio access network receives this message 66C and forms a short data burst message 66D that includes the 100TRYING content. The radio access network further extracts the SECTOR information and uses this information to specify the communication pathway/resources/endpoints to be used when transmitting this message 66D to the communication unit.

Upon receiving this 100TRYING message (or such other message as can be interpreted and/or defined as an affirmative indication that the target communication unit will likely be available), the communication unit can optionally provide 68 a signal to the communication unit user and/or can begin buffering audio information as may be input by the user. So configured, the communication unit can permit a user to initiate a speaking portion of the desired communication earlier than has typically been possible with many prior art approaches. The communication unit can then proceed with whatever signaling and protocol may be appropriate and/or necessary in a given system to complete the establishment of the desired dedicated talk channel including, for the purpose of illustration, transmission of an ORIGINATION message 69A to the radio access network (which can cause, for example, the latter to initiate a corresponding SERVICE REQUEST message 69B to the mobile switching center in accord with prior art practice).

These teachings are sufficiently powerful and flexible to permit a wide variety of embodiment options. These teachings can be employed to effect a greatly reduced period of latency between when a communication unit user asserts a push-to-talk button and receives a corresponding speak indicator. These teachings can also be employed to significantly reduce system resource requirements when merely informing a communication unit user that a given target communication unit is not presently likely available. Other benefits include but are not limited to the potential to avoid or at least reduce glare under at least some operating circumstances and the potential to accommodate other message content including presence information updates. Many of these benefits are attainable with only relatively minor alterations to existing infrastructure configurations.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method to facilitate establishment of a first type of wireless communication resource to facilitate communications with at least a first communication target comprising:
transmitting a message using a second type of wireless communication resource, wherein the message at least identifies the first communication target;
waiting for reception of a message using the second type of wireless communication resource wherein the message comprises an affirmative response;
upon receiving the affirmative response, transmitting at least one additional message using the second type of wireless communication resource to seek establishment of the first type of wireless communication resource.

2. The method of claim 1 wherein the first type of wireless communication resource comprises a dedicated channel and wherein the second type of wireless communication resource comprises a common channel.

3. The method of claim 1 and further comprising, upon receiving the affirmative response, providing a user-perceivable signal.

4. The method of claim 1 and further comprising buffering verbal user input as received prior to completing a communication link to the first communication target via the first type of wireless communication resource.

5. The method of claim 4 wherein the communications with at least a first communication target further comprise push-to-talk communications with at least a first communication target.

6. The method of claim 1 wherein transmitting a message using a second type of wireless communication resource further comprises transmitting a short data burst message on a common channel communication resource.

7. The method of claim 6 wherein waiting for reception of a message using the second type of wireless communication resource further comprises waiting for reception of a short data burst message on a paging channel communication resource.

8. The method of claim 7 wherein transmitting a short data burst message on a common channel communication resource further comprises transmitting an INVITE message.

9. The method of claim 8 wherein waiting for reception of a message using the second type of wireless communication resource wherein the message comprises an affirmative response further comprises waiting for reception of a short data burst message on the paging channel communication resource wherein the message comprises at least one of:
a 100 TRYING message;
a 200 OK message;
informational content corresponding to at least one of:
a previous call having ended due to loss of a sufficient radio frequency carrier;
age of available presence information;
a previous call attempt having failed due to expiration of an attempt window;
unavailability of a required quorum of communication targets when seeking to facilitate establishment of the first type of wireless communication resource to facilitate communications with a plurality of communication targets.

10. The method of claim 1 and further comprising, while waiting for reception of a message using the second type of wireless communication resource wherein the message comprises an affirmative response, and upon receiving a second message using the second type of wireless communication resource wherein the second message comprises a negative response, concluding a present attempt to establish the first type of wireless communication resource.

11. The method of claim 10 wherein the second message comprising a negative response comprises at least one of:
a 486 BUSY message;
a 404 NOT FOUND message;
a 421 INCORRECT FORMAT message;
a 480 TEMPORARILY UNAVAILABLE message;
a 500 INTERNAL SERVER ERROR message.

12. A method to facilitate establishment of a first type of wireless communication resource to facilitate communications with at least a first communication target comprising:
receiving a first message from a communication location via a second type of wireless communication resource and via a communication location, wherein the second type of wireless communication resource is different from the first type of wireless communication resource and wherein the first message identifies the first communication target;
storing information regarding the communication location;
determining whether the first communication target is likely available for communications;
using the information regarding the communication location to transmit a second message to the communication location via the second type of wireless communication resource, wherein the second message corresponds to likely availability of the first communication target.

13. The method of claim 12 wherein the first type of wireless communication resource comprises a dedicated channel and wherein the second type of wireless communication resource comprises a common channel.

14. The method of claim 12 wherein the first type of wireless communication resource comprises a voice communication resource and the second type of wireless communication resource comprises a data communication resource.

15. The method of claim 13 wherein:
receiving a first message comprises receiving a short data burst message; and
using the information regarding the communication location to transmit a second message comprises using the information regarding the communication location to transmit a short data burst message.

16. The method of claim 12 wherein storing information regarding the communication location further comprises storing information regarding the communication location at a packet control function (PCF).

17. The method of claim 12 wherein storing information regarding the communication location further comprises storing information regarding the communication location at a mobile switching center (MSC).

18. The method of claim 12 wherein storing information regarding the communication location further comprises storing information regarding a wireless endpoint sector that corresponds to the communication location.

19. The method of claim 12 and further comprising:
receiving a third message from the communication location via the second type of wireless communication resource and via a corresponding communication location, wherein the third message comprises a presence update message;
storing information regarding the corresponding communication location;
determining updated presence information;
using the information regarding the corresponding communication location to transmit a fourth message to the communication location via the second type of wireless communication resource, wherein the fourth message comprises, at least in part, the updated presence information.

20. The method of claim 12 and further comprising:
inhibiting, until at least a predetermined trigger event, transmissions to the communication location via the second type of wireless communication resource.

21. The method of claim 20 wherein the predetermined trigger event comprises, at least in part, expiration of a predetermined period of time.

22. The method of claim 12 wherein using the information regarding the communication location to transmit a second message to the communication location via the second type of wireless communication resource, wherein the second message corresponds to likely availability of the first communication target further comprises using the information regarding the communication location to transmit a second message to the communication location via the second type of wireless communication resource, wherein the second message corresponds to:
likely availability of the first communication target; and
presence information as corresponds to the communication location.

23. A core network element comprising:
a radio access network (RAN) interface;
a push-to-talk server interface;
a memory having stored therein communication pathway information for a communication location seeking to establish a push-to-talk communication on a dedicated communication channel with a target communication unit.

24. The core network element of claim 23 and further comprising:
push-to-talk facilitation means for using the communication pathway information to forward information regarding likely availability of the target communication unit to the communication location via a communication resource other than the dedicated communication channel.

25. The core network element of claim 24 wherein the push-to-talk facilitation means uses the communication pathway information by providing the communication pathway information to a RAN via the RAN interface such that the RAN can use the communication pathway information to provide the information regarding likely availability of the target communication unit to the communication location by selective limited use of a shared paging communication resource.
